(19) United States
(12) Patent Application Publication
(10) Pub. No.: US 2005/0033593 A1
(43) Pub. Date: Feb. 10, 2005

(54) Service bureau system and method for providing service assistance

(76) Inventor: James d. Abrams, Sarasota, FL (US)

Correspondence Address: HARNESS, DICKEY, & PIERCE, P.L.C, 7700 BONHOMME, STE 400, ST. LOUIS, MO, 63105, US

(21) Appl. No.: 10/854,475

(22) Filed: May 26, 2004

Related U.S. Application Data
(60) Provisional application No. 60/492,823, filed on Aug. 6, 2003.

(51) Int. Cl. G06F 17/60

(52) U.S. Cl. 705/1; 705/6

(57) ABSTRACT

A service bureau system and method for assisting a user in retaining a service from a service provider selected from a plurality of service providers providing a plurality of different services. The system includes a receiving module receiving a service request from the user and identifying the user. The system also includes a service representative module having an input receiving an instruction from a service representative. The instruction includes a selection of one of the plurality of service providers. The system further includes a communication module establishing a communication between the service representative and the user responsive to receiving the user service request. The system also includes a scheduling module scheduling the selected service provider to provide the requested service.

### RELATED APPLICATIONS

This application claims priority to U.S. Provisional Patent Application No. 60/492,823, filed Aug. 6, 2003, entitled DEVICE AND METHOD FOR PROVIDING ONE-BUTTON REPAIR SERVICE ASSISTANCE, which is incorporated by reference herein in its entirety.

Also, this patent application is related to U.S. Non-provisional patent application entitled DEVICE AND METHOD FOR PROVIDING SERVICE ASSISTANCE, attorney number 2678-000010US, which is being filed concurrently with this patent application.

### RELATED FIELD

The invention generally relates to a system and method for requesting and offering a plurality of different services to a service user. More particularly, the invention is a system and method related to one-button user access to a service bureau for a service from among a plurality of different services. A service provider is scheduled by the service bureau to provide the requested service to the user.

### GENERAL BACKGROUND

A residential or business owner often requires a variety of services related to their home or business. These services include installation and/or repair of such systems or items as: heating, ventilation, air conditioning, plumbing, masonry, cement, roofing, flooring, glass/windows, lawn service, small engine repair for lawn mowers, automotive, carpentry, drywall, sheet metal, telephone, data wiring, television, audio system, video system, computer, communication network, communication system, painting, gutter, lawn equipment, appliance (such as washer, dryer, oven, stove, refrigerator), tree service, electrical, water leakage, insect or varmint control, and landscaping.

To obtain a service, a user often refers to the yellow pages, local newspapers, webpages, obtain referrals from neighbors or friends, business cards, stickers, billboards, placards, old invoices, etc. However, the user must select one service provider from a plurality of service providers each of which provides only a limited quantity of the plurality of different services. Typically a service provider offers only a few of the services and they are only competent at specific installations and repairs. As such, a user is required to select a service provider for each and every service required by the requested service. Once selected, the user individually contacts that selected service provider to schedule the providing of the service. Once the service is provided to the user, the service provider provides the user with an invoice for the provided service. The user typically receives only a limited or implied warranty or guarantee for the provided service.

Each of the service providers typically must depend on yellow pages, local newspapers, internet web-pages, obtain referrals from neighbors or friends, business cards, stickers, billboards, and placards to advertise, market, and sell their services to potential users in need of similar services. It is often by luck or chance that a particular service provider receives a service call from a user in need of an installation or repair service. While service providers often join industry-specific consortium or associations for marketing of services, generally, there is no method or system for a service provider to find out about the installation and repair needs and potential business opportunities for small business and residential customers.

In order to increase the likelihood of repeat business or referrals, it is not uncommon for an installation or repair service provider to leave behind a business card, a placard, or a sticker bearing the name and phone number of the service provider. This is done in the hope that the customer will reference the card, placard, or sticker and again call upon that service provider when the user requires similar or related repair or maintenance in the future. For example, a service provider may place (or attempt to place) a sticker on a particular item or piece of equipment or at a location associated with a particular item, e.g., a sticker on or near the user's thermostat, water heater, air conditioner, and garage door. However, users often regard such service provider identification stickers as unattractive. Therefore, many users quickly remove the stickers, while others request that they not be placed in the first place. Consequently, the next time the user requires a service, the user might not call on the same service provider as originally installed the item or as they did in the past. In many cases, the user does not recall which service provider was used in the past. Not only does this result in lost business for the service provider, it also represents an increased burden on the user, who must bother with finding a new service provider, such as by selecting from an unfamiliar list of service providers in a telephone business directory or local newspaper. In the alternative, a service provider may leave behind a business card or flyer. However, users often dispose of the business card or flier or fail to refer to them for a later service need.

Also the user must trust the reputation or recommendations from other users with regard to the quality service provided by a service provider. Generally, there is not a method or system for quality control for the service providers other than negative reports in a local Better Business Bureau or consumer organization. As each service provider provides its own quality control and each provides its own warranty or guarantee, issues of quality and warranty for the provided service can cause poor relationships or ill will with customers.

As recognized by the inventor hereof, there is a need for a means for home owners and small business owners in need of an installation or repair service to conveniently obtain the requested service from a repair service provider on demand. There is also a need for an improved method to enable a user to easily contact a qualified service provider when an installation or repair service is needed. There is also a need by a service provider to increase the volume of business and improve sales and sales contacts. There is further a need for improved quality control and certification for services such that users have a known warranty or guaranteed associated with the service prior to and after the delivery of the service.

### SUMMARY

In one aspect the invention is a service bureau system for assisting a user in retaining a service from a service provider selected from a plurality of service providers providing a plurality of different services. The system includes a receiving module receiving a service request from the user and identifying the user. The system also includes a service representative module having an input receiving an instruction from a service representative. The instruction includes a selection of one of the plurality of service providers. The system further includes a communication module establishing a communication between the service representative and the user responsive to receiving the user service request. The system also includes a scheduling module scheduling the selected service provider to provide the requested service.

In another aspect the invention is a service bureau system for retaining a service from a service provider from a plurality of service providers providing a plurality of different services in response to a user request for the service. The system includes a communication module receiving the user request for the service and receiving user data. The system also includes a service provider module storing service provider information including one or more services provided by the service provider. The system further includes a service provider quality of service module storing a quality of service rating for at least one of the plurality of service providers. The system also includes a selection module selecting the service provider from the plurality of service providers as a function of the user request, the user data, the service provider information, and the service provider quality of service rating.

In another aspect, the invention is a method of assisting a user in obtaining a service from one of a plurality of service providers providing a plurality of different services. The method includes receiving a user service request at a service bureau that represents the plurality of service providers providing the plurality of different services. The method also includes identifying user data of the user sending the user service request and initiating a response communication to the user as a function of receiving the service request and the identified user data. The method further includes receiving user service information communicated by the user as a function of the response communication. The user service information includes a service requested by the user. The method also includes storing service provider information for the plurality of service providers including the different one or more services provided by each of the plurality of service providers. The method further includes scheduling the one service provider from the plurality of service providers to perform the requested service as a function of the stored service provider information.

In yet another aspect, the invention is a method of providing a repair service to a user. The method includes receiving a user repair service request at a service bureau. The service bureau represents a plurality of repair service providers providing a plurality of different repair services. The method also includes communicating with the user to receive user repair service information. The method further includes storing service provider information for the plurality of repair service providers where the repair service provider information includes a repair service provider quality of service rating. The method also includes selecting one repair service provider from the plurality of repair service providers as a function of the received user repair service information and the stored repair service provider information including the repair service provider quality of service rating.

Other aspects and features of the present invention will be in part apparent and in part pointed out hereinafter.

### BRIEF DESCRIPTION OF THE DRAWINGS

FIG. 1 is a block diagram of a service assistance device according to one embodiment of the invention.

FIG. 2 is a front illustration of a thermostat incorporating a service assistance device according to another embodiment of the invention.

FIG. 3 is a block diagram of a service assistance system according to another embodiment of the invention.

FIG. 4 is a block diagram of a service bureau according to one embodiment of the invention.

FIG. 5 is a flow chart illustrating one embodiment of a method for providing service assistance utilizing a repair service assistance device and a repair service bureau.

Corresponding reference characters and designations generally indicate corresponding parts throughout the drawings.

### DETAILED DESCRIPTION

In one embodiment, a service assistance system is provided to request one or more services from a service bureau. The service bureau is a central service contact for a plurality of service providers offering a plurality of different services. In one embodiment, the plurality of different services is any service that may be required or desired by a home or business owner.

Such services may include, but are not limited to, repair, installation, or removal services associated with: heating, ventilation, air conditioning, plumbing, masonry, cement, roofing, flooring, glass/windows, lawn service, small engine repair for lawn mowers, automotive, carpentry, drywall, sheet metal, telephone, data wiring, television, painting, gutter service, lawn equipment, appliances (such as washer, dryer, refrigerator), tree service, electrical, water leakage, insect or varmint control, and landscaping. These services may be any type of installation, cleaning, repair, or removal service for a property owner. In one preferred embodiment, the requested service is a repair service requiring a repair service from a repair service provider.

A system and method according to some embodiments of the invention provides an improved method for accessing providers of services taking a single action, such as pushing a single button. By push a single button or taking a single action, support systems and methods are initiated to provide the user with service assistance in obtaining and scheduling a service provider to address the user's service needs. In other embodiments, the requesting of a repair service may be in response to a service event, lapse of time, outage, error, or cycle that may have been predetermined to require service by a service provider.

A service assistance system may include a service request device for requesting one of the plurality of different services to be provided by one of the plurality of service providers. The system may also include a memory that stores one or more communication addresses or contact information for automatically contacting or notifying the service bureau. A communication module is included for communicating a service in response to the service request device to the service bureau to the stored communication address.

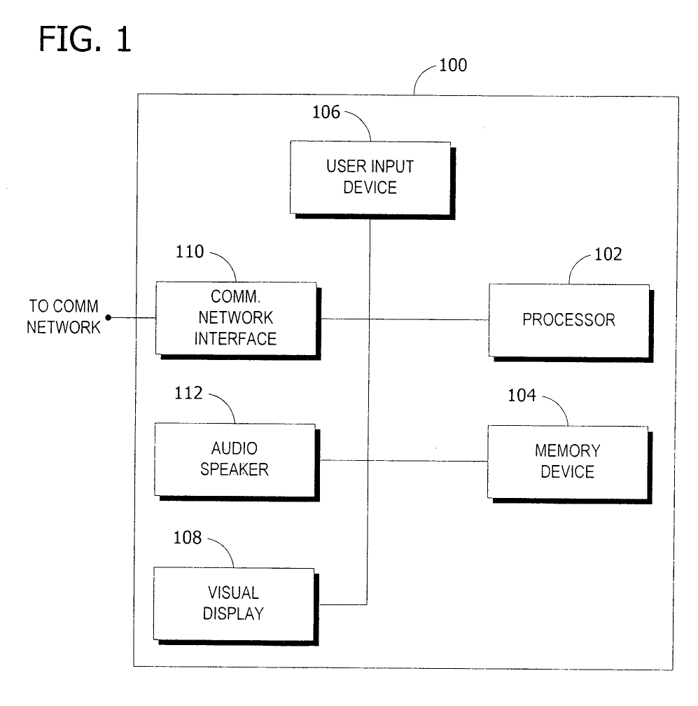

Referring now to FIG. 1, one embodiment of a system for assisting a homeowner, business owner, or other user in obtaining a service from a service provider is illustrated. A service assistance system 100 includes a user input device 106, a memory 104, a communication module or network interface 110. A processor 102, audio speaker 112 and/or visual display 108 may also be included. Memory 104 includes information related to contacting a service bureau such as a telephone number, a data network ID, a name, or computer instructions for execution by processor 102. Memory 104 may comprise one or more static and/or dynamic memory elements.

In one preferred embodiment, user input device 106 is a push-button momentary switch, whereby a user may provide input to service assistance system 100 by depressing the push-button switch. As should be apparent, however, other types of user input devices, including other types of switches, touch screens, keyboards, touch pads, mouses, joysticks, voice recognition devices, etc., can be utilized as user input device 106 without departing from the scope of the invention. Communication network module 110 provides an interface for communication over a communication network. Communication network module 110 may be the interface to a telephone network, a wireless network, a data network, a local area network, a wide area network, a satellite network, or an optical network.

Communication network module 110 is provided to enable automated communications over the communication network between service assistance system 100 and the remotely situated repair service bureau. In one preferred embodiment, communication network module 110 is a telephone interface (e.g., a modem) for enabling automated communications with a remotely situated service contractor over a telephone network. Alternatively, communication network module 110 may be, for example, a computer network interface device for permitting service assistance system 100 to communicate with remote service contractors through a computer network including, for example, through the Internet via email. Processor 102 may be operatively connected to user input device 106, memory 104, and communication network module 110. Processor 102 may be configured to contact a service bureau through the communication network using communication network interface 110 and contact information stored in memory 104 responsive to the user initiating an automated signal indicative of the request for service. In another alternative embodiment, memory 104 stores a prerecorded message and processor 102 provides the prerecorded message to the service bureau over communication network module 110.

In another embodiment, processor 102 or application software stored in memory 104 may provide one or more optional features or capabilities. For instance, a service request administration module may be processed by processor 102 in conjunction with one or more remote systems (not shown). For example, processor 102 may be configured to identify an occurrence of an event for which an automatic service request should be generated by service assistance system 100. An operating event may include a lapse of a time or timer such as the lapse of time since a last maintenance or a pending lapse of a warranty. Operating event may also include an error in a system, an outage of a system or piece of equipment, an alarm, or a lapse of a number of cycles. These operating events may be predetermined within software running on processor 102 to automatically generate a service request. In such a case, an automatic service code may be sent to service bureau 306 indicating the operating event and automatic generation of the service request.

Display 108 and/or speaker 112 may provide a visual or audio output representing information stored in memory 104 or actions initiated by processor 102. Audio speaker 112 and/or visual display 108 may be included in service assistance system 100 for providing troubleshooting and other information to users in audio and/or visual formats. In a preferred embodiment, Visual display 108 may be a liquid crystal display (LCD). Also, a transmitter (not shown) may be included to provide, in conjunction with speaker 112, a communication capability to service assistance system 100, whereby the user may communicate with the service bureau. An embodiment with such a transmitter and a receiver enable the transmitter and said receiver to operate in cooperation with communication network module 110 and the communication network to provide a two-way communication between the user located at service assistance system 100 and a service representative or technician located at the service bureau.

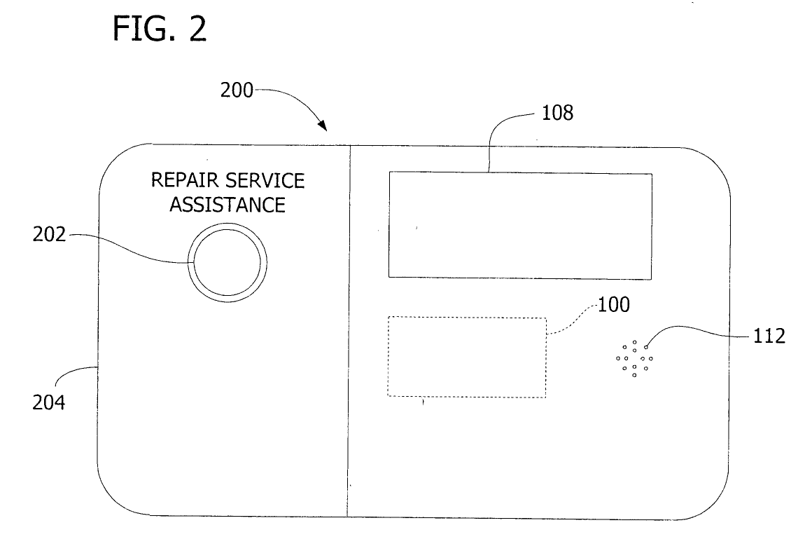

Service assistance system 100 may be a standalone device. In the alternative, service assistance system 100 may be incorporated into another device or appliance such as a thermostat, a telephone, a personal computer, an electric appliance, an electric service cabinet, etc. For example, illustrated in FIG. 2 is service assistance system 100 incorporated in thermostat 200 that is associated with a heating and/or cooling system. Thermostat 200 includes a housing 204, a push-button switch 202 (corresponding to user input device 106) by which a user can input a request for service assistance, display 108, and audio speaker 112. Components of service assistance system 100 such as memory 104, processor 102, display 108, and speaker 112 may be combined with other features and functions of thermostat 200. In another embodiment, input device 106 may be a mouse or pointer on a personal computer accessing a webpage.

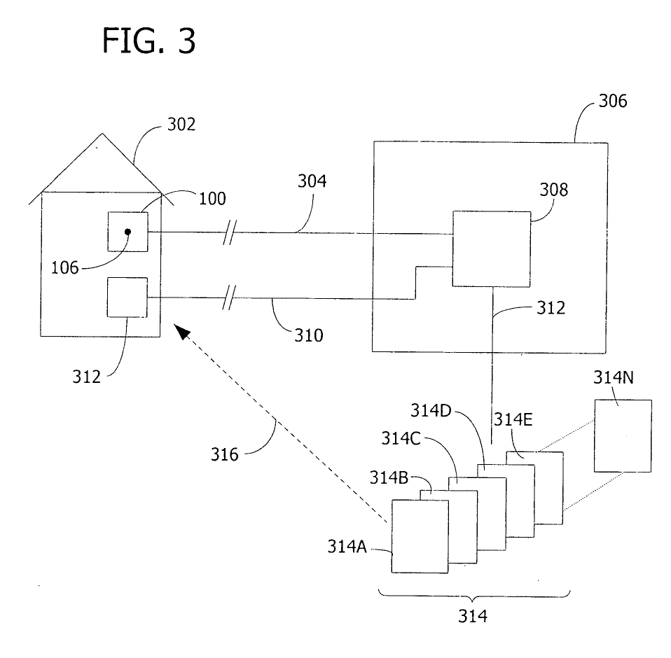

FIG. 3 illustrates a system for providing service assistance with service assistance system 100 and a remotely situated service bureau 306. Service assistance system 100 is often located at user premise or location 302. Input device 106 is located on service assistance system 100. Service assistance system 100 is connected to a communication network 304. Service bureau 306 is usually located at a centralized location that is remote from a plurality of user locations 302. Service bureau 306 may be hosted and/or operated by a service bureau host such as a power company, a municipal organization, a telecommunication company, a gas company, a utility company, and a telemarketing company. Service bureau 306 may be comprised of one or more service bureau systems 308 that receive the service request transmitted from service assistance system 100 over communication network 304. Service bureau system 308 may also connect to a second communication network 310. While second communication network 310 is illustrated as a separate telephone or data communication network from communication network 304, in another embodiment they may be the same network as communication network 304.

Service bureau system 308 may be coupled via communication facility 312 to a plurality of service providers 314, each of which is shown as 314A, 314B, etc. to 314N. One of the plurality of service providers is selected by service bureau 306, service bureau system 308, the user, or the service representative to perform the service requested by the user. The providing or delivery of the requested service by the selected service provider to user is indicated as dotted line 316.

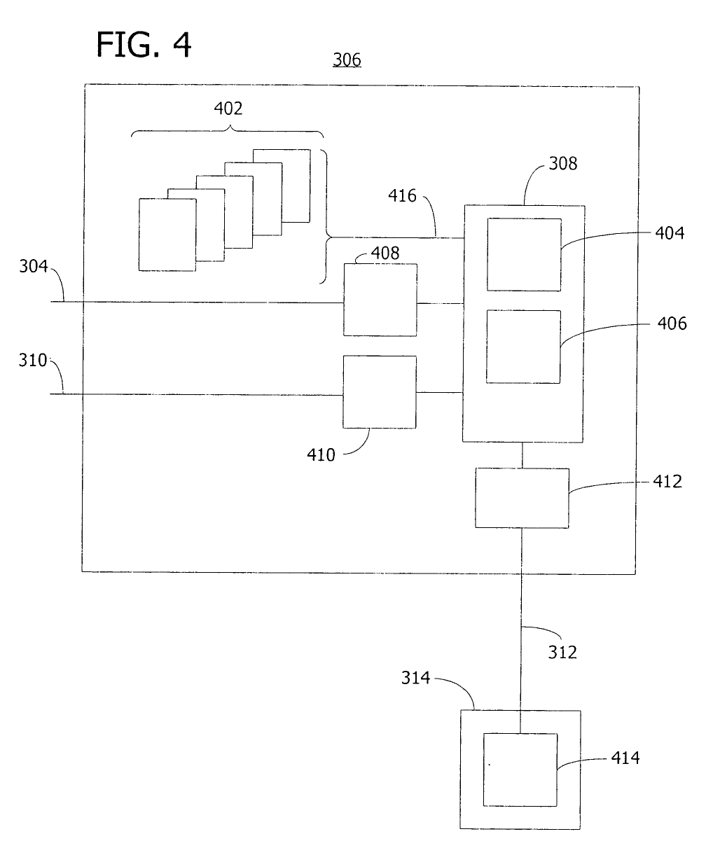

Referring now to FIG. 4 is one embodiment of service bureau 306. Service bureau system 308 may include a user request module 408 that receives the request signal from one or more service assistance devices 100. User request module 408 is configured to receive the service request signal from communication network 304 and to determine the identity of the requesting user and related user contact information and account information. In one embodiment, this may be identifying the calling party number (CPN) from an incoming telephone call. Service bureau system 308 may include one or more processors 404 and one or more memory devices or modules 406. Second communication network module 410 accesses second communication network 310 for providing a response communication with the user. Also included is a service provider interface 412 that communicates over communication link 312 to one or more service providers 314 or to service provider system 414.

Service bureau 306 also includes one or more customer service representative workstations 402 which are connected to service bureau system 308. Workstation 402 is accessed by a customer service representative who, utilizing the systems and functions of service bureau system 308 in conjunction with communication with the user, may determine the user service requirements, and as a function of a communication with one or more service providers 314 or service provider systems 414, determines a particular one of the plurality of service providers 314 to provide the service to the user. Processor 308 in conjunction with input from a customer service representative utilizing customer service workstation 402 may determine a schedule for the delivery of the service by a selected service provider 314. The selection of the service provider may be based on a predetermined quality of service rating for one or more service providers related to the requested service. In the alternative, the selection may be based on a predetermined or stored schedule or availability of one or more service providers to provide the requested service. For example, in one embodiment, one or more of the service providers 314 may provide an availability schedule to service bureau 306. In an alternative embodiment, service bureau 306 may interact with one or more service provider systems 414 to coordinate availability and scheduling.

Once the selected service provider 314 delivers the scheduled service to the user, the service provider 314 may transmit service cost or billing information to the user or to service bureau system 308 via communication link 312 or via alternative means such as the physical delivery via the mail, express mail, or via email over the Internet. In one embodiment service bureau system 308 may initiate a bill invoice to the user as a function of the transmitted service cost or billing information transmitted by service provider 314. In this embodiment, when the user pays the invoiced bill to service bureau 306, service bureau 306 provides an associated payment to service provider 314. In another embodiment, service bureau 306 combines or incorporates the user invoice into another invoice sent to the user. For example, where the service bureau host is an electric utility company, the service invoice for a repair service such as a plumbing repair may be included in the next electric utility invoice to the user.

In another embodiment, service bureau system 308 comprises a receiving module for receiving a signal indicative of a request for service assistance and determining an identity of the user and contact information associated with the determined identification of the user. Also included is a communication module for establishing a communication link between the user and a service representative at workstation 402 in response to receiving the signal and as a function of the determined contact information. A scheduling module provides for scheduling a service provider to perform a requested service as a function of received requested service information, wherein service provider 314 is one of a plurality of service providers.

In another embodiment, service bureau 306 with service bureau system 308 may be configured to provide a guarantee for the delivery of the service to the user. To accomplish this, service bureau system 308 is configured to collect and retain quality control input, measurements and statistics related to each of the plurality of service providers 314. A quality control rating may be assigned to one or more service providers 314.

In one embodiment, the selection of a service provider may be based at least in part as a function of quality rating. For example, each service provider 314 having a quality control rating greater than or equal to a pre-established level may be deemed to be a certified service provider 314 of service bureau 306. Any service provider 314 having a quality control rating less than the pre-established level will not be certified. In the later case, a non-certified service provider 314 would not be selected or scheduled to provide services by service bureau 306. The selection and scheduling of a service provider 314 by service bureau system 308 and the service customer service representative utilizing workstation 402 is a function of the available quality control rating for each service provider 314.

In operation, service bureau 306 or service bureau system 308 selects and schedules the service provider 314. Once the delivery of the service to the user is complete, if the user is not satisfied of the delivered service, the service bureau 306 will either not bill or invoice the user for some or all of the amount associated with the service failing to meet the user's satisfaction, provider an equivalent credit on a bill, or schedule to have the service delivered an additional time by the same service provider such as 314A or by an alternate service provider such as 314N. In this manner, the user is assured that when he/she requests a service with user input device 106, they will not only receive a timely callback (within a predetermined period of time such as 15 minutes), but will also have a qualified and certified service provider 314 scheduled to provide the requested service. The user will be guaranteed satisfaction of the delivered service by the service bureau 306.

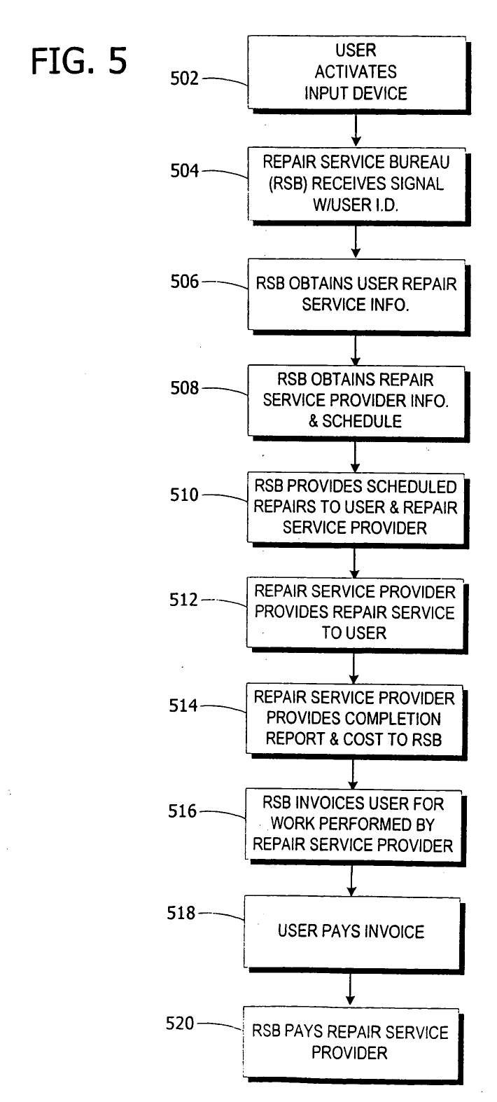

FIG. 5 provides a block diagram of one embodiment of the method of operation of one or more embodiments of the invention described herein. It is assumed that user premise 302 has been equipped by service assistance system 100. In such a case, the operating entity or provider of service bureau 306 may have installed service assistance system 100 at user premise 302 and may have programmed service assistance system 100 to communicate with its own service bureau system 308. As one example, a local utility such as a local power company may install service assistance system 100 such that when activated by the user, service assistance system 100 transmits a message to the utility's customer service center which is functioning as service bureau 306 and which is equipped with service bureau system 308.

When the user activates input device 106 of service assistance system 100, a signal is transmitted in block 502 from service assistance system 100 over communication network 304 to service bureau 306 and to service bureau system 308. Service bureau system 308 receives the signal in block 504 that includes a user indicator or user identification for determining the identity of the user. If communication network 304 is a telephone network, identification may be by caller identification service as transmitted in the signal or may be a recorded announcement as recorded in memory 104 of service assistance system 100. In one embodiment, a service representative accessing one of service customer representative workstations 402 initiates a communication with the requesting user within a predefined period of time. In one preferred embodiment, the predefined period of time is fifteen (15) minutes. However, other periods of time may also be identified and still be within the scope of the present invention.

As noted in block 506, a service customer service representative may obtain the service information from the requesting user by initiating a series of questions. Additionally, the service customer service representative accesses service bureau system 308 to access user data stored in memory 406. Such information may include a history of prior problems, warranty information/parameter, prior service providers who have provided services to the user, and user information related to customer preferences, location, account billing information, etc. Similarly, service bureau system 308 obtains service provider information in block 508 from one or more of a plurality of service providers 314 which may provide the requested service to the user. The availability or schedule for each of the plurality of service providers 314 may be included. From such information, the customer service representative and/or service bureau system 308 determines a schedule in block 510 for a service provider 314 to provide the requested service to the user.

In one embodiment, a warranty module (not shown) within service bureau system 308 may identify for the requested service one or more warranty parameters or terms and conditions. The warranty information may be provided to the user at various stages in conjunction with the requesting, selecting, or providing of the service. For example, a warranty disclosure document may be generated and provided to the user.

In block 512, service provider 314 provides the requested service to the user. Upon completion of providing the requested service to the user, the service provider 314 provides a completion report or indication to service bureau system 308 along with associated costs for providing such service in block 514. In block 516, service bureau system 308 initiates a billing invoice to the user for the service work performed by service provider 314. This invoice could be a standalone invoice or one combined with another invoice such as associated with or incorporated in a standard monthly billing for an electric utility company. The user typically pays the invoice by submitting payment to service bureau 306 who provided the billing invoice in block 518. Finally, service bureau 306 provides payment to service provider 314 that provided the service to the user. FIG. 5 is just one embodiment of a method according to the invention. One or more of these operations as indicated by the blocks may be eliminated or combined with other systems or functions in other embodiments. For example, the bill invoicing operation may be performed by a billing system of an electric utility company or other billing party or entity.

A system and method according to various embodiments and implementations of the invention provide improved service assistance to users. Some embodiments provide a simplified service input device and method for requesting a service. The system provides a service request notification to a service system and associated service bureau in response to a user input or an occurrence of an event or condition. The service system receives the notification and initiates a communication with the user. The service system generates a service order for a particular service to a service provider. The service system receives billing information from the service provider related to the provided service provided by the service provider. The service system generates invoicing information related to the provided particular service. The quality of the delivered service is guaranteed by the service bureau to insure customer satisfaction.

As can now be appreciated, the systems and methods herein described provide substantial advantages over the prior art. Such advantages include improved and simplified access to one or more service providers and a single customer service interface to a user for all requested services. Also among the advantages are improved sales and marketing of service provider services to users.

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

Those skilled in the art will note that the order of execution or performance of the methods illustrated and described herein is not essential, unless otherwise specified. That is, it is contemplated that aspects or steps of the methods may be performed in any order, unless otherwise specified, and that the methods may include more or less operations or steps than those disclosed herein.

As various changes could be made in the above exemplary constructions and methods without departing from the scope of the invention, it is intended that all matter contained in the above description or shown in the accompanying drawings shall be interpreted as illustrative and not in a limiting sense. It is further to be understood that the steps described herein are not to be construed as necessarily requiring their performance in the particular order discussed or illustrated. It is also to be understood that additional or alternative steps may be employed with the present invention.

1. A service bureau system for assisting a user in retaining a service from a service provider selected from a plurality of service providers providing a plurality of different services, the system comprising:
a receiving module receiving a service request from the user and identifying the user;
a service representative module having an input receiving an instruction from a service representative, said instruction including a selection of one of the plurality of service providers;
a communication module establishing a communication between the service representative and the user responsive to receiving the user service request; and
a scheduling module scheduling the selected service provider to provide the requested service.

2. The system of claim 1, further comprising a service provider quality of service module including a quality of service rating for one or more of the plurality of service providers, wherein the quality of service rating is a function of module received customer feedback and wherein the scheduling module schedules the selected service provider, at least in part, as a function of each of the quality of service rating.

3. The system of claim 1 wherein the scheduling module receives a service provider availability schedule from the selected service provider, said scheduling module scheduling the selected service provider as a function of the received service provider availability schedule.

4. The system of claim 1, further comprising an invoicing module receiving an invoice amount from the selected service provider and generating a user invoice as a function of the received invoice amount.

5. The system of claim 1 wherein the user invoice for the received service is included in an invoice for at least one of a utility bill, a gas invoice, an electric invoice, a telecommunication invoice, a cable TV invoice, and a municipal service invoice.

6. The system of claim 1, further comprising a warranty module identifying a warranty parameter associated with the service provided by the selected service provider and generating a user warranty disclosure that includes the warranty parameter.

7. The system of claim 1 wherein the plurality of different services provided by the plurality of service providers includes two or more services selected from the group consisting of a repair service, an installation service, a heating service, a ventilation service, an air conditioning service, a plumbing service, a masonry service, a roofing service, a flooring service, a window service, a glass service, a siding service, a concrete service, a carpentry service, a walling service, a wall paper service, a lawn service, a small engine repair service, an automotive service, a television service, a computer service, a telecommunication service, a wiring service, an electrical service, a painting service, an appliance service, a washer service, a dryer service, a stove service, a refrigerator service, a tree service, an insect service, a landscaping service, a foundation service, a pest control service, a deck repair service, and a drywall service.

8. The system of claim 1 wherein the service bureau system is hosted by a service bureau host, said service bureau host being selected from the group consisting of a power company, municipal organization, a telecommunication company, a gas company, a utility company, and a telemarketing company.

9. The system of claim 1, further comprising an invoicing module receiving a service cost from the selected service provider following completion of the providing of the requested service to the user and generating a user invoice billing the user for the provided service.

10. A service bureau system for retaining a service from a service provider from a plurality of service providers providing a plurality of different services in response to a user request for the service, the system comprising:
a communication module receiving the user request for the service and receiving user data;
a service provider module storing service provider information including one or more services provided by the service provider;
a service provider quality of service module storing a quality of service rating for at least one of the plurality of service providers; and
a selection module selecting the service provider from the plurality of service providers as a function of the user request, the user data, the service provider information, and the service provider quality of service rating.

11. The system of claim 10 wherein the selection module includes a service provider availability schedule, said selection module selecting the service provider as a function of the service provider availability schedule.

12. The system of claim 10, further comprising a scheduling module including a service provider availability schedule, said scheduling module scheduling the service provider to perform the service as a function of the service provider availability schedule.

13. The system of claim 10, further comprising a warranty module identifying a warranty parameter associated with the service to be provided by the service provider.

14. The system of claim 10, further comprising an invoicing module receiving a service cost from the service provider and generating a user invoice as a function of the received service cost.

15. The system of claim 10 wherein the plurality of different services provided by the plurality of service providers includes two or more services selected from the group consisting of a repair service, an installation service, a heating service, a ventilation service, an air conditioning service, a plumbing service, a masonry service, a roofing service, a flooring service, a window service, a glass service, a siding service, a concrete service, a carpentry service, a walling service, a wall paper service, a lawn service, a small engine repair service, an automotive service, a television service, a computer service, a telecommunication service, a wiring service, an electrical service, a painting service, an appliance service, a washer service, a dryer service, a stove service, a refrigerator service, a tree service, an insect service, a landscaping service, a foundation service, a pest control service, a deck repair service, and a drywall service.

16. The system of claim 10 wherein the service bureau system is operated by a service bureau host, said service bureau host being selected from the group consisting of a power company, a municipal organization, a telecommunication company, a gas company, a utility company, and a telemarketing company.

17. A method of assisting a user in obtaining a service from one of a plurality of service providers providing a plurality of different services, the method comprising:
receiving a user service request at a service bureau, said service bureau representing the plurality of service providers providing the plurality of different services;
identifying user data of the user sending the user service request;
initiating a response communication to the user as a function of receiving the service request and the identified user data;
receiving user service information communicated by the user as a function of the response communication, said user service information including a requested service;
storing service provider information for the plurality of service providers including the different one or more services provided by each of the plurality of service providers; and
scheduling the one service provider from the plurality of service providers to perform the requested service as a function of the stored service provider information.

18. The method of claim 17 wherein the received request is a function of a single user input for retaining one of the plurality of different services from the plurality of service providers.

19. The method of claim 17 wherein the receiving the user service request is receiving a communication from at least one of a telephone network, a wireless network, a data network, a local area network, a wide area network, a satellite network, and an optical network.

20. The method of claim 17 wherein the identifying user data includes identifying a calling party number parameter.

21. The method of claim 17, further comprising providing a service assistance device to the user for transmitting the user service request to the service bureau.

22. The method of claim 21 wherein the service assistance device is housed in at least one of a thermostat, a telecommunication device, and a stand alone housing.

23. The method of claim 22 wherein the service assistance device includes a user input device having two states wherein one of the two states initiating the transmitting of the user service request.

24. The method of claim 17 wherein the response communication is initiated within a guaranteed predetermined time from receiving the service request at the service bureau.

25. The method of claim 24 wherein the guaranteed predetermined time is about fifteen minutes.

26. The method of claim 17 wherein a service bureau representative determines a service required by the user as a function of the user service information, further comprising selecting the one service provider from the plurality of service providers as a function of the requested service, the user data, and the service provider information.

27. The method of claim 17, further comprising:
receiving a service cost from the service provider; and
generating a user invoice as a function of the received service cost.

28. The method of claim 27, further comprising receiving a customer feedback that the service provided by the service provider was less than satisfactory, wherein generating the user invoice includes providing a credit for at least a portion of the service cost.

29. The method of claim 17 wherein initiating a response communication includes initiating a voice telephone call to the user.

30. The method of claim 17, further comprising determining a quality of service rating for one or more of the plurality of service providers, wherein scheduling of the one service provider is a function of the quality of service rating for the one service provider.

31. The method of claim 17 wherein the plurality of different services provided by the plurality of service providers includes two or more services selected from the group consisting of a heating service, a ventilation service, an air conditioning service, a plumbing service, a masonry service, a roofing service, a flooring service, a window service, a glass service, a siding service, a concrete service, a carpentry service, a walling service, a wallpapering service, a lawn service, a small engine repair service, an automotive service, a television service, a computer service, a telecommunication service, a wiring service, an electrical service, a painting service, an appliance service, a washer service, a dryer service, a stove service, a refrigerator service, a tree service, an insect service, a landscaping service, a foundation service, a pest control service, a deck repair service, and a drywall service.

32. A method of providing a repair service to a user, the method comprising:
receiving a user repair service request at a service bureau representing a plurality of repair service providers providing a plurality of different repair services;
communicating with the user to receive user repair service information;
storing service provider information for the plurality of repair service providers, said repair service provider information including a repair service provider quality of service rating; and
selecting one repair service provider from the plurality of repair service providers as a function of the received user repair service information and the stored repair service provider information including the repair service provider quality of service rating.

33. The method of claim 32, further comprising providing the user with a user repair service request device for transmitting the user repair service request, said user repair service request device having a single input for requesting any one of the plurality of different repair services from the plurality of repair service providers.

34. The method of claim 32, further providing a repair service response guarantee to the user receiving the repair service request device such that the communicating with the user is within a predetermined time from the transmitting a user repair service request.

35. The method of claim 32, further providing a repair quality of service guarantee to the user, said repair quality of service guarantee including at least one of a providing of an additional providing of the repair service and a credit to an invoiced cost associated with the provided repair service.

36. The method of claim 32, further providing a user invoice to the user in combination with an invoice for a utility service.

37. The method of claim 32 wherein the plurality of different repair services provided by the plurality of repair service providers includes two or more services selected from the group consisting of a heating service, a ventilation service, an air conditioning service, a plumbing service, a masonry service, a roofing service, a flooring service, a window service, a glass service, a siding service, a concrete service, a carpentry service, a walling service, a wallpaper service, a lawn service, a small engine repair service, an automotive service, a television service, a computer service, a telecommunication service, a wiring service, an electrical service, a painting service, an appliance service, a washer service, a dryer service, a stove service, a refrigerator service, a tree service, an insect service, a landscaping service, a foundation service, a pest control service, a deck repair service, and a drywall service.
